(19) United States
(12) Patent Application Publication
(10) Pub. No.: US 2015/0241575 A1
(43) Pub. Date: Aug. 27, 2015

(54) Radiation Detector

(71) Applicant: Hitachi Aloka Medical, Ltd., Tokyo (JP)

(72) Inventors: Kenichi NAGASHIMA, Tokyo (JP); Yasuhiko SUZUKI, Tokyo (JP)

(21) Appl. No.: 14/631,964

(22) Filed: Feb. 26, 2015

(30) Foreign Application Priority Data
Feb. 27, 2014 (JP) 2014-037104

(51) Int. Cl. G01T 1/24

(52) U.S. Cl. CPC G01T 1/243; G01T 1/241

(57) ABSTRACT

A radiation detector includes a plurality of radiation detecting devices (semiconductor devices) having a plane of incidence where coming radial rays enter. The radiation detecting devices are arranged in a manner that the planes of incidence are arranged side by side substantially without any space therebetween, when the planes of incidence are viewed from a direction along which radial rays come. The plurality of radiation detecting devices are arranged in a manner that heights in a normal direction of the planes of incidence of the plurality of radiation detecting devices differ from heights in a normal direction of the planes of incidence of respective adjacent other radiation detecting devices.

### CLAIM OF PRIORITY

The present application claims priority from Japanese Patent application serial no. 2014-037104, filed on Feb. 27, 2014, the content of which is hereby incorporated by reference into this application.

### TECHNICAL FIELD

The present invention relates to a radiation detector.

### BACKGROUND ART

Japanese Unexamined Patent Application Publication No. 2005-26419 discloses an image pickup apparatus which injects the radioactive material into a test object and detects the intensity distribution of radial rays generated from this radioactive material, thereby imaging the inside of the test object. The apparatus has a plurality of detecting units which detect the intensity of the radial rays generated from the radioactive material. The detecting units have the characteristic of generating electrical charges by irradiation of the radial rays, and have a plurality of semiconductor devices and a conductive member. The plurality of semiconductor devices are arranged side by side and closely crowded together substantially in a surface direction without any space therebetween, include a first electrode on a first surface where the radial rays enter, and include a second electrode on a second surface opposed to the first surface. The conductive member electrically connects the plurality of first electrodes and causes the first electrodes to have the same electric potential.

Japanese Unexamined Patent Application Publication No. 2010-185752 discloses that there is provided a radiation detector which includes a semiconductor device, a substrate with the semiconductor device fixed thereonto, and a supporting member. The semiconductor device can detect the radial rays. The supporting member supports the substrate in an adjacent part of the semiconductor device.

### SUMMARY OF THE INVENTION

### Technical Problem

According to the semiconductor radiation detector (hereinafter referred to as a face-on type semiconductor radiation detector) disclosed in Japanese Unexamined Patent Application Publication No. 2005-26419 and the semiconductor radiation detector (hereinafter referred to as an edge-on type semiconductor radiation detector) disclosed in Japanese Unexamined Patent Application Publication No. 2010-185752, there is an attempt to improve the sensitivity or the resolution, by arranging the plurality of semiconductor devices side by side substantially without being in contact with each other and without any space therebetween and by not forming a part without any semiconductor device.

To arrange the semiconductor devices substantially without any space therebetween, it is necessary to maintain a very slight space (for example, 100 μm) and to prevent electrical contact between the adjacent semiconductor devices. This requires very high processing accuracy, and its maintainability (change of the semiconductor devices) is difficult. In the case of the face-on type semiconductor radiation detector, it is difficult to connect between the bottom surface side and the top surface side of the semiconductor devices using wirings, by arranging them substantially without any space therebetween.

The present invention has been made to solve these problems, and an object thereof is to realize a radiation detector exercising high performance, excellent processability, and excellent maintainability.

According to one invention, there is provided a radiation detector comprising a plurality of radiation detecting devices which have planes of incidence where incoming radial rays enter, and the radiation detecting devices being arranged in a manner that the planes of incidence are arranged side by side substantially without any space therebetween when viewed from a direction along which the radial rays come, and wherein heights in a normal direction of the respective planes of incidence of the plurality of radiation detecting devices differ from heights in a normal direction of planes of incidence of respective adjacent other radiation detecting devices.

### Advantageous Effect of the Invention

According to the present invention, it is possible to realize the radiation detector exercising high performance, excellent processability, and excellent maintainability.

### BRIEF DESCRIPTION OF DRAWINGS

FIG. 1 is a perspective diagram of a face-on type semiconductor radiation detector 100.

FIG. 2 is an arrow cross sectional view obtained by cutting the semiconductor radiation detector 100 along a line A-A′ in FIG. 1.

FIG. 3 is a plan view illustrating a state of semiconductor devices 101 and 102 whose corner parts are cut off.

FIG. 4 is a cross sectional view of the semiconductor radiation detector 100 and a collimator 412, wherein the collimator 412 are added into the arrow cross sectional view of FIG. 2.

FIG. 5 is a cross sectional view of the semiconductor radiation detector 100 and the collimator 412, in the case where the collimator 412 is configured in a manner that the peripheries of low-stage semiconductor devices are expanded and emission parts of radial rays in holes are adjacent respectively to pixels of the holes.

FIG. 6 is a plan view illustrating a state in which corner parts 603 are in contact with each other among the lower-stage semiconductor devices with the expanded peripheries.

FIG. 7 is a plan view illustrating a state in which the corner parts of the lower-stage semiconductor devices are cut off.

FIG. 8 is a perspective view of the face-on type semiconductor radiation detector 100 in a case where the semiconductor devices 101 and 102 are made in a substantially flat triangular prismatic form in a Z-axis direction.

FIG. 9 is a perspective view of an edge-on type semiconductor radiation detector 900.

FIG. 10A is a diagram for explaining a state of the array of semiconductor devices 901 and 902 on the first surface of a card substrate 903, and FIG. 10B is a diagram for explaining a state of the array of the semiconductor devices 901 and 902 on the second surface of the card substrate 903.

FIG. 11 is a perspective view of the edge-on type semiconductor radiation detector 900.

FIG. 12A is a diagram for explaining a state of the array of the semiconductor devices 901 on the first surface of the card substrate 903, and FIG. 12B is a diagram for explaining a state of the array of the semiconductor devices 902 on the second surface of the card substrate 903.

### DESCRIPTION OF THE PREFERRED EMBODIMENTS

Preferred embodiments of the present invention will specifically be described with reference to the drawings.

### First Embodiment

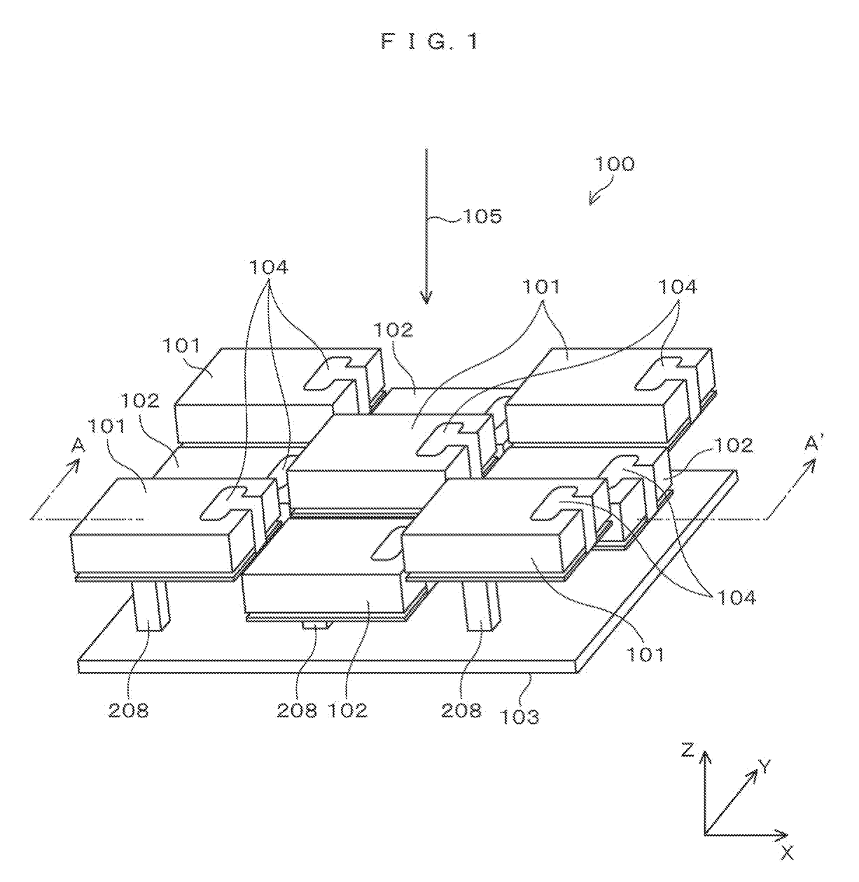

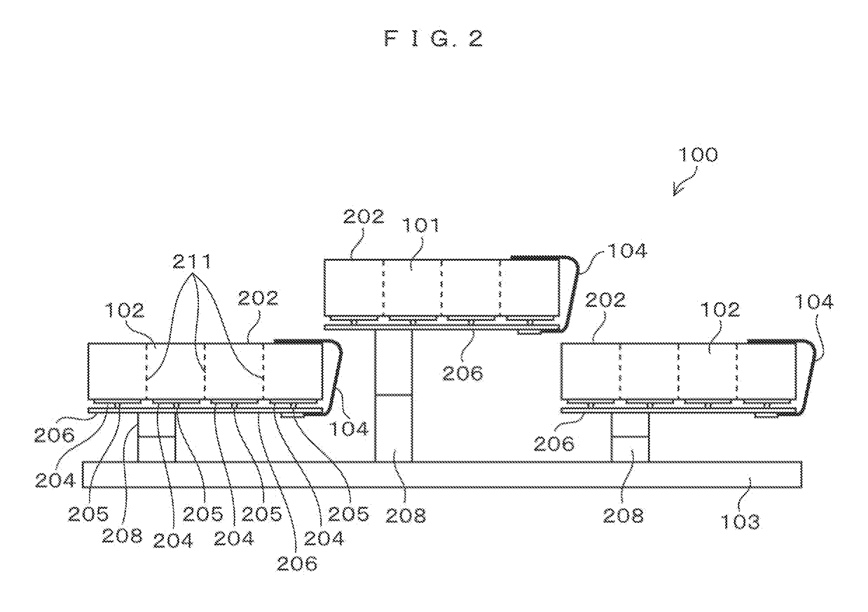

FIG. 1 is a perspective view of a face-on type semiconductor radiation detector 100, as will be described as the First Embodiment. FIG. 2 is an arrow cross sectional view obtained by cutting the semiconductor radiation detector 100 along a line A-A′ in FIG. 1. As illustrated in these illustrations, the semiconductor radiation detector 100 includes a substantially plane rectangular backboard 103 and a plurality of semiconductor devices 101 and 102 (radiation detecting devices) which are aligned and arranged in matrix (3 rows*3 columns, in this embodiment) on one surface of the backboard 103.

In this embodiment, the three-dimensional coordinate system XYZ is set in a manner that an XY plane is parallel to the backboard 103. In the above coordinate system, a +Z direction may be referred to as “above” or “upward”, while a −Z direction may be referred to as “below” or “downward”.

As illustrated in this drawing, the semiconductor devices 101 and 102 show to have a substantially flat rectangular parallelepiped form in a Z-axis direction. In this embodiment, the semiconductor devices 101 and 102 have the same form and same size. However, the form and size of the semiconductor devices 101 and 102 are not necessarily the same. The semiconductor devices 101 and 102 are formed of materials of, for example, silicone, germanium, CdTe, CdZnTe, TlBr, HgI₂, GaAs.

The semiconductor devices 101 and 102 have the upper surface as the plane of incidence of radial rays, and detect radial rays 105 coming from upward. Both of the upper surfaces of the plurality of semiconductor devices 101 and 102 are parallel to each other (parallel to the XY plane). The plurality of semiconductor devices 101 and 102 are provided in a manner that heights (heights from the upper surface of the backboard 103) in a normal direction (Z-axis direction) of the respective upper surfaces differ from heights of the respective upper surfaces in a normal direction (Z-axis direction) of adjacent other semiconductor devices 101 and 102, that is, in a manner that there is a height difference (a level difference) between the upper surfaces of the respective adjacent semiconductor devices 101 and 102. When the plurality of semiconductor devices 101 and 102 are entirely viewed from a direction (from upward) that the radial rays come along the normal direction of the respective planes of incidence, the upper surfaces (the planes of incidence) of the plurality of semiconductor devices 101 and 102 are arranged side by side and closely crowded together substantially without any space therebetween.

In this embodiment, the heights of the upper surfaces (Z-axis direction) of the semiconductor devices 101 and 102 in the normal direction are the same alternately (that is, the upper surfaces have only two different heights). However, the upper surfaces may have three or more different heights. A group of semiconductor devices 101 with the upper surface are also referred to as “upper-stage semiconductor devices”, while a group of semiconductor devices 102 with the lower upper surface are also referred to as “lower-stage semiconductor devices”.

As illustrated in FIG. 2, some conductive substance (for example, platinum (chemical symbol (Pt))) is evaporated on the upper surface of the semiconductor devices 101 and 102, thereby forming a common electrode 202. The conductive substance (for example, platinum (chemical symbol (Pt))) is evaporated on a plurality of places of the lower surfaces of the semiconductor devices 101 and 102, thereby forming a plurality of individual electrodes 204. In this embodiment, sixteen individual electrodes 204 (four semiconductor devices are arranged on one side, thus 4*4=16 for one semiconductor device) with an equal area are formed on each one of the semiconductor devices 101 and 102. Because the plurality of individual electrodes 204 are formed, each one of the semiconductor devices 101 and 102 is electrically parted for a plurality of pixels (In FIG. 2, broken lines with a numeral 211 is virtual parting lines for pixels).

The semiconductor devices 101 and 102 are both fixed through bumps 205 (soldering ball or conductive adhesive) onto the upper surface of a circuit board 206 which is supported at a predetermined height by connectors 208 provided on the upper surface of the backboard 103. The bumps 205 electrically connect between the individual electrodes 204 of the semiconductor devices 101 and 102 and the predetermined positions of the wiring pattern on the circuit board 206. The connectors 208 electrically connect between the circuit board 206 and the backboard 103, and also structurally support the circuit board 206. There is a difference between a height (length in a Z-axis direction) of the connector 208 supporting the circuit board 206 with the upper-stage semiconductor device formed thereon and a height (length in a Z-axis direction) of the connector 208 supporting the circuit board 206 with the lower-stage semiconductor device formed thereon. The height difference therebetween causes a height difference (a level difference) between the upper surface (a plane of incidence) of the upper-stage semiconductor device and the upper surface (a plane of incidence) of the lower-stage semiconductor device.

One end of the wiring of a flexible printed wiring board 104 is connected to a predetermined position of the circuit board 206. The other end of the wiring of the flexible printed wiring board 104 is connected to the common electrode 202 of the upper surfaces of the semiconductor devices 101 and 102. The flexible printed wiring board 104 applies a high DC voltage, supplied from the circuit board 206, between the common electrode 202 and the individual electrodes 204 of the semiconductor devices 101 and 102. This DC voltage causes the voltage gradient in a normal direction of (Z-axis direction) the plane of incidence, inside the semiconductor device 101.

If the radial rays coming from, upward the semiconductor radiation detector 100 enter the semiconductor devices 101 and 102, electrons and positive holes are generated inside the semiconductor devices 101 and 102. These are separated into the side of the common electrode 202 and the side of the individual electrodes 204 due to the above-described voltage gradient, thereby generating an electrical signal. That is, the radial rays that have entered the pixels of the semiconductor devices 101 and 102 are read out as the above-described electrical signal from the individual electrodes 204 corresponding to the pixels. The read electrical signal is provided to an analyzer, such as an information processor (computer), in a corresponding manner to the pixels, and is used for distribution analysis on radial rays emitted from a test object.

Accordingly, in the semiconductor radiation detector 100 of this embodiment, there is a height difference (a level difference) between the upper surfaces (planes of incidence) of the adjacent respective semiconductor devices 101 and 102. However, when the plurality of semiconductor devices 101 and 102 are entirely viewed from a direction (from upward) that the radial rays come along the normal direction of the respective planes of incidence, the upper surfaces (the planes of incidence) of the plurality of semiconductor devices 101 and 102 are arranged side by side and closely crowded together substantially without any space therebetween. Thus, the radial rays coming from upward can be measured with high performance (high sensitivity and high resolution), like the case where no height difference (a level difference) is made therebetween.

By forming this height difference (a level difference), a space is three-dimensionally formed between the adjacent semiconductor devices (the semiconductor devices 101 and 102). Thus, high processing accuracy is not required, unlike the case where they are arranged in plane without making a height difference (a level difference), resulting in excellent processability (productivity) or excellent maintainability (change of semiconductor devices). With the utilization of the above space, it is possible to easily perform wiring (for example, the wiring of the flexible printed wiring board 104 illustrated in FIG. 2) for connecting between the upper surface side and the lower surface side of the semiconductor devices 101 and 102.

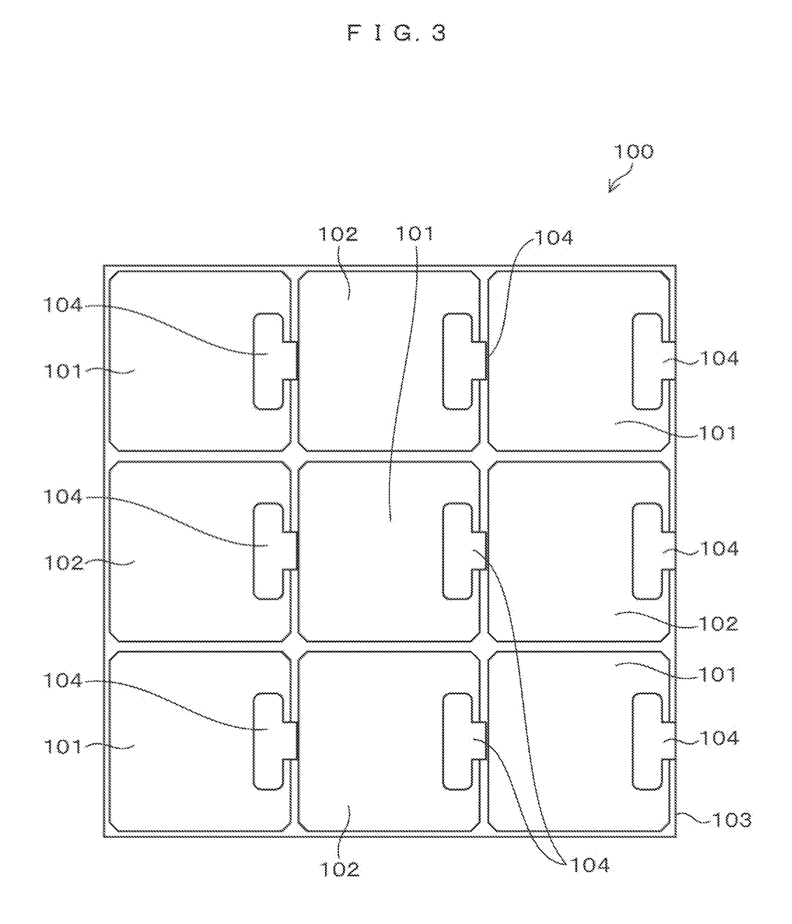

The corner parts (edges) of the upper-stage semiconductor devices or the lower-stage semiconductor devices may be in contact with each other. This can be solved by cutting off the corner parts of the semiconductor devices 101 and 102, for example, as illustrated in FIG. 3. If necessary, the corner parts of the circuit board 206 may be cut off together with those of the semiconductor devices 101 and 102.

Usually, the face-on type semiconductor radiation detector 100 is used in a state where the collimator 412 (a parallel multihole collimator) is provided upward on the upper surface (plane of incidence) of the respective semiconductor devices 101 and 102. The collimator 412 is provided for the purpose of restricting the direction of radial rays entering the pixels, and is formed of materials, such as lead or tungsten (chemical symbol of W) for shielding the radial rays.

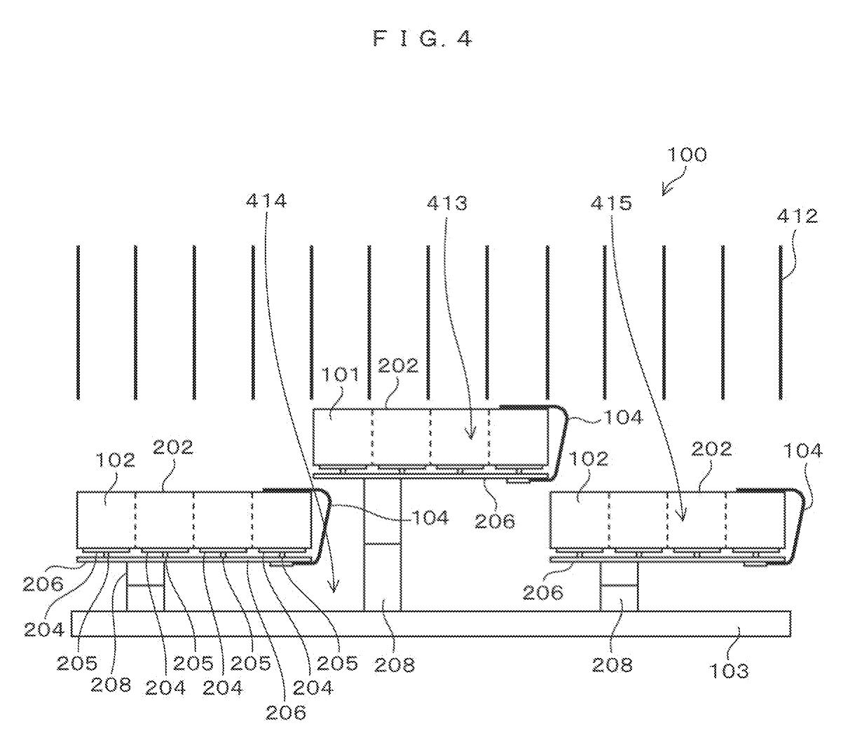

FIG. 4 is a cross sectional view of the semiconductor radiation detector 100 and the collimator 412, wherein the collimator 412 is added into the arrow cross sectional view of FIG. 2. When there is a height difference (a level difference) between the upper surfaces (planes of incidence) of the adjacent respective semiconductor devices, some cases may be assumed. In one case, like radial rays identified by a reference numeral 414 in the illustration, the radial rays get through between the adjacent respective semiconductor devices 101 and 102. In another case, the radial rays may enter pixels different from original target pixels, like radial rays identified by a reference numeral 415 in the illustration.

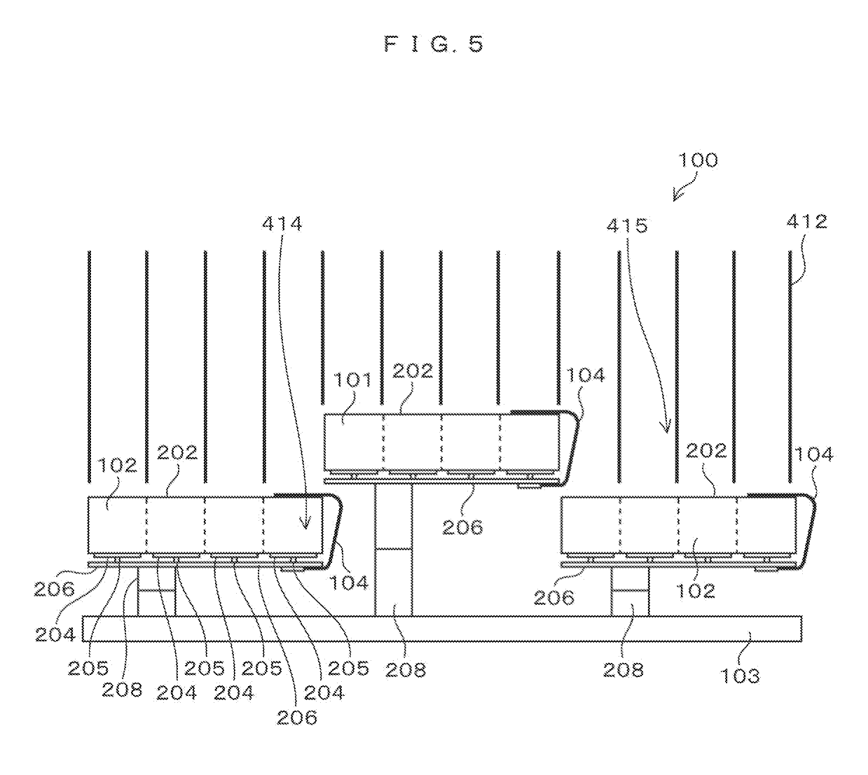

In the former case, for example, as illustrated in FIG. 5, the peripheries (their areas) of the upper surfaces (the planes of incidence) of the lower-stage semiconductor devices are expanded. The planes of incidence of the plurality of respective semiconductor devices 101 and 102 are viewed from a direction (+Z direction) that the radial rays come along the normal, direction. Then, at this time, to overcome the problem, at least a part of the peripheries of the upper surfaces (planes of incidence) of the lower-stage semiconductor devices are made to overlap the peripheries of the upper surfaces (the planes of incidence) of the upper-stage semiconductor devices. As a result, for example, as illustrated in the same drawing, the getting-through radial rays 414 in the case of FIG. 4 can definitely be made to enter the lower-stage semiconductor devices. To overcome the latter case, the collimator 412 is configured in a manner that emission parts of the radial rays in holes are adjacent to pixels corresponding to the holes. Specifically, for example, as illustrated in the drawing, the lower ends of the collimator 412 are extended up adjacent to the lower-stage semiconductor devices.

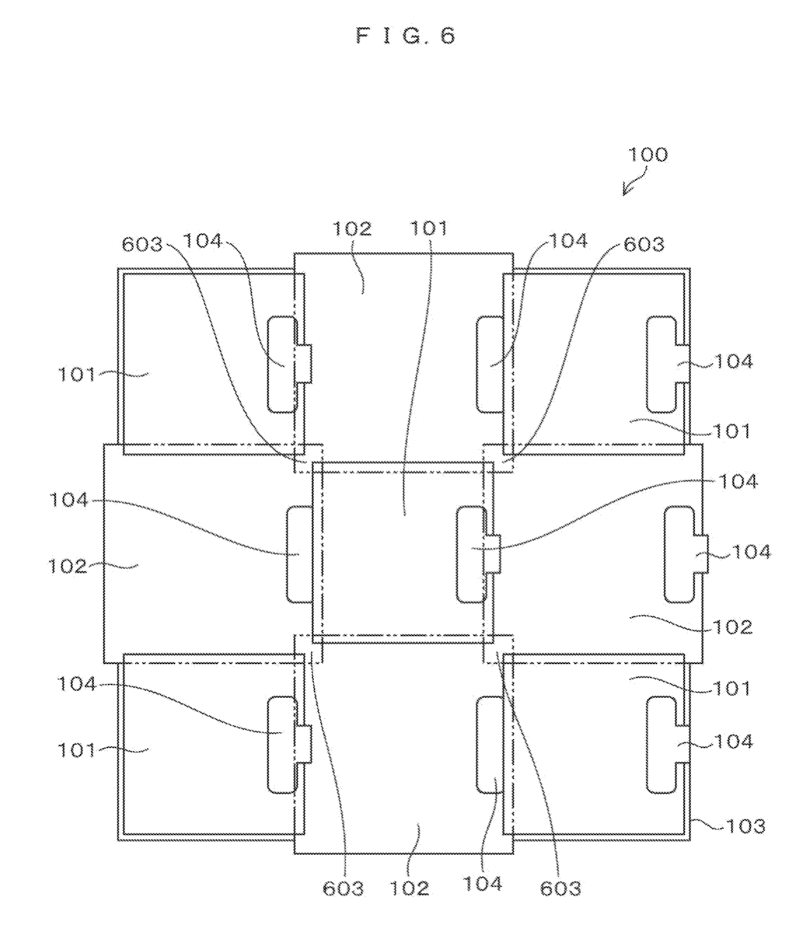

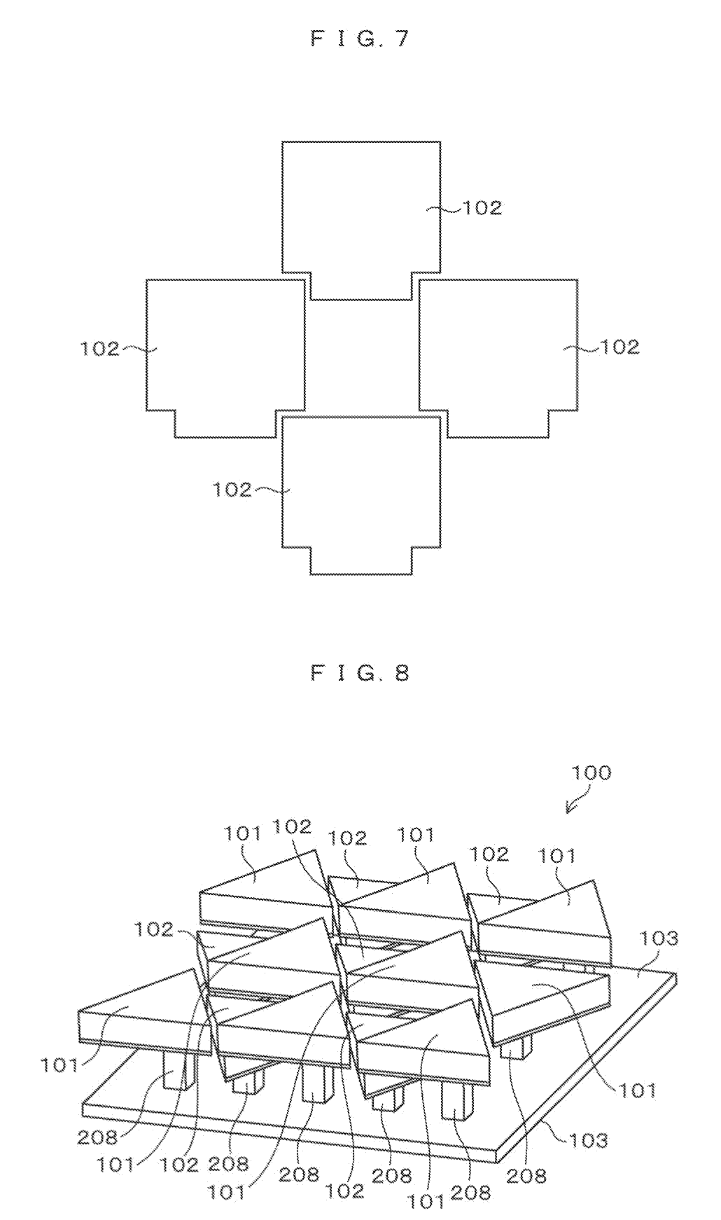

If the areas of the upper surfaces (planes of incidence) of the lower-stage semiconductor devices are expanded for the purpose of solving the former case, the corner parts 603 of the adjacent respective lower-stage semiconductor devices may possibly be in contact with each other, as illustrated in FIG. 6. This can be solved by cutting off the corner parts 603 of the lower-stage semiconductor devices to an extent sufficient to prevent the contact of the corner parts 603, as illustrated in FIG. 7. For example, if the heights of the upper surfaces of the semiconductor devices are more varied (for example, from the two stages of the upper and lower stages to three stages of the upper, middle, and lower stages), it is possible to reduce the possibility that the semiconductor devices run into each other.

Accordingly, the descriptions have been made to the case where the semiconductor devices have a substantially rectangular parallelepiped form. However, the form of the semiconductor devices is not limited to this. It is enough that the upper surfaces (planes of incidence) of the plurality of semiconductor devices may be closely crowded together substantially without any space therebetween, when the plurality of semiconductor devices are entirely viewed from a direction (from upward) that the radial rays come along the normal direction of the respective planes of incidence. For example, as illustrated in FIG. 8, the semiconductor devices 101 and 102 are made in a substantially flat triangular prismatic form in a Z-axis direction. The same effect can be attained as described above, when the semiconductor devices are made in this form. Other than the substantially flat triangular prismatic form, other variation of various polygons (substantially a flat hexagon form in an Z-axis direction) can possibly be considered.

### Second Embodiment

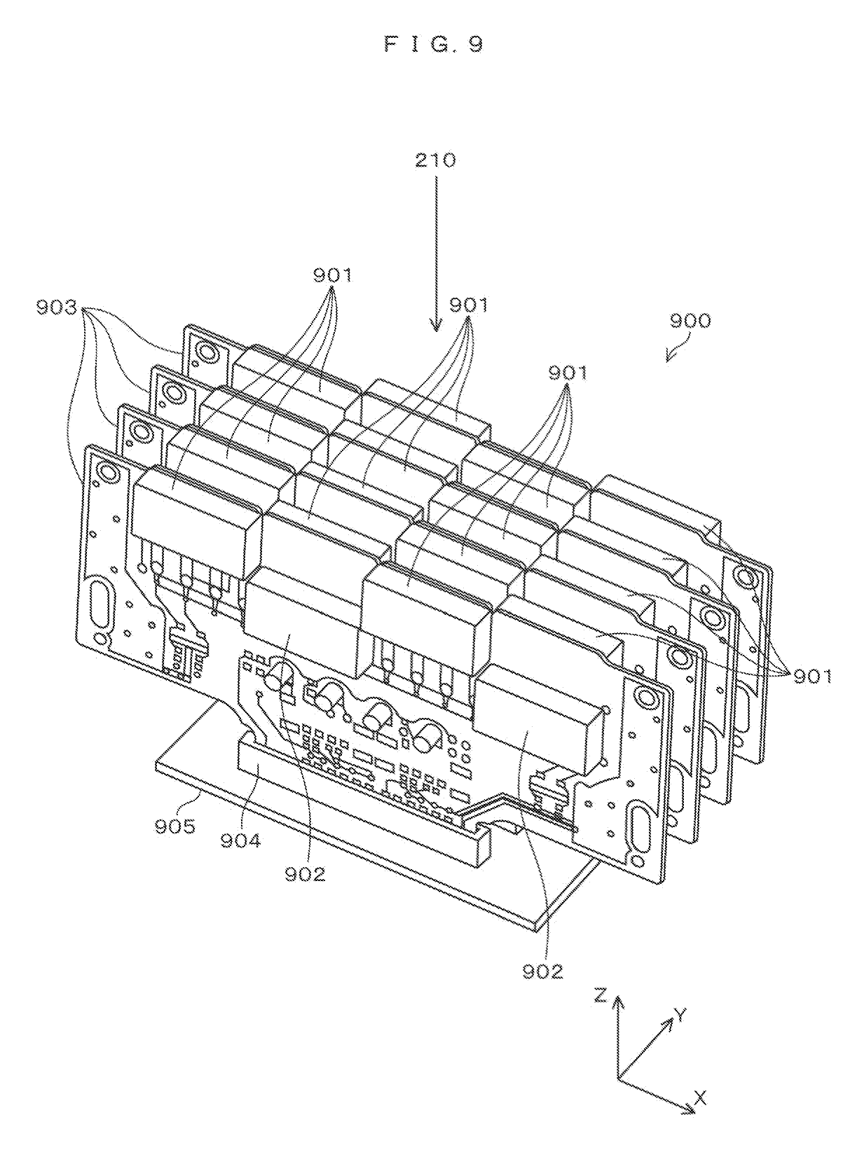

FIG. 9 is a perspective view of an edge-on type semiconductor radiation detector 900, as will be described in the Second Embodiment. As illustrated, the semiconductor radiation detector 900 includes a main substrate 905 in a substantially plane rectangular form and a plurality of card substrates 903. The substrates 903 are in a substantially rectangular form and respectively set with a plurality of connectors 904 that are aligned and arranged at equal intervals on one surface of the main substrate 905. Hereinafter, the three-dimensional coordinate system XYZ is set in a manner that an XY plane is parallel to the main substrate 905. In the above coordinate system, a +Z direction may be referred to as “above” or “upward”, while a −Z direction may be referred to as “below” or “downward”.

The card substrate 903 has an insertion unit which projects in order to set the card substrate 903 with the connector 904 of the main substrate 905, in the vicinity of the center part of one long side in a substantially rectangular form. The connectors 904 of the main substrate 905 structurally support the card substrates 903 to electrically connect the card substrates 903 with the main substrate 905, and to maintain the card substrates 903 to stand vertically on the surface of the main substrate 905. The card substrates 903 stand above the main substrate 905, in a state where electronic components mounted respectively therein are adjacent to each other not to be in contact with each other among the adjacent card substrates 903. In this embodiment, the main substrate 905 has the four connectors 904 arranged at equal intervals along a Y-axis direction, and has the four card substrates 903 attached to the main substrate 905 with using these connectors 904.

Each of the card substrates 903 has a plurality of semiconductor devices 901 and 902 implemented thereon. The semiconductor devices 901 and 902 are fixed with solder or conductive adhesive, in the vicinity of the other long side of both sides of the card substrate 903. In the case of this embodiment, the four semiconductor devices 901 and 902 (i.e. totally eight) are provided on each surface of one card substrate 903, and the semiconductor radiation detector 900 includes totally thirty two semiconductor devices 901 and 901. The card substrate 903 has various components, such as resistance elements or capacitive elements that are implemented thereon, other than the semiconductor devices 901 and 902. As illustrated, the semiconductor devices 901 and 902 show to have a substantially flat rectangular parallelepiped form in a Y-axis direction. In this embodiment, the semiconductor devices 901 and 902 have the same form and same size. However, the form and the size of the semiconductor devices 901 and 902 are not limited to this.

Each of the semiconductor devices 901 and 902 has a plane of incidence of radial rays in its upper surface (surface toward a +Z direction), and detects radial rays 210 coming from upward. Unlike the case of the face-on type in the First Embodiment, the semiconductor devices 901 and 902 receive a DC voltage which causes the voltage gradient in a direction of 90 degrees (in a normal direction of the surface of the card substrates 903 in this embodiment) against the normal direction of the respective planes of incidence.

The upper surfaces (the planes of incidence) of the semiconductor devices 901 and 902 are parallel to each other (parallel to the XY plane). The plurality of semiconductor devices 901 and 902 vided in a manner that heights (heights from the upper surfaces of the main substrate 905) in a normal direction (a Z-axis direction) of the respective upper surfaces differ from heights in a normal direction (a Z-axis direction) of the respective upper surfaces of adjacent respective other semiconductor devices 901 and 902, that is, in a manner that there is a height difference (a level difference) between the upper surfaces of the respective adjacent semiconductor devices 901 and 902. When the plurality of semiconductor devices 101 and 102 are entirely viewed from a direction (from upward) that the radial rays come along the normal direction of the respective planes of incidence, the upper surfaces (the planes of incidence) of the plurality of semi conductor devices 901 and 902 are arranged side by side closely crowded together substantially without any space therebetween.

In this embodiment, the heights in a normal direction of the upper surfaces (the Z-axis direction) of the semiconductor devices 901 and 902 are the same alternately (that is, the upper surfaces have only two different heights). However, the upper surfaces may have three or more different heights. Hereinafter, a group of semiconductor devices 901 with the higher upper surface are also referred to as “upper-stage semiconductor devices”, while a group of semiconductor devices 902 with the lower upper surface fare also referred to as “lower-stage semiconductor devices”.

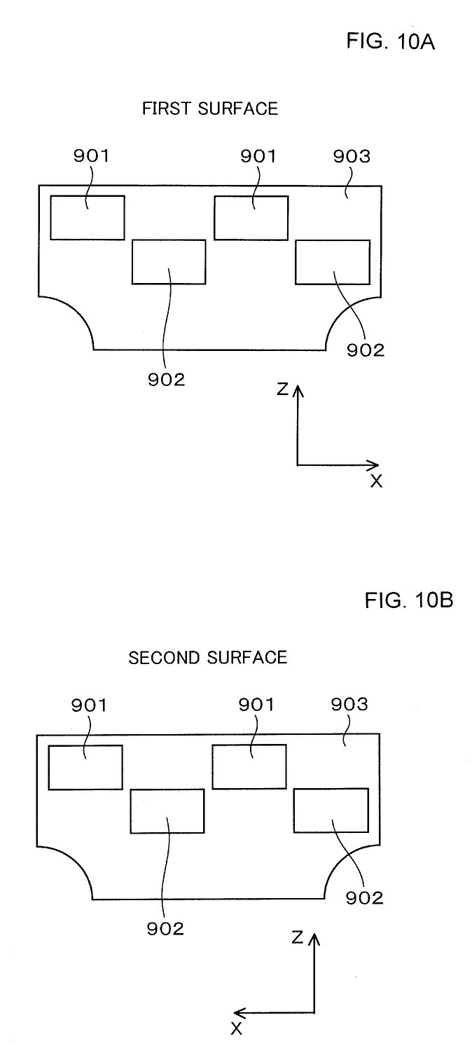

FIG. 10 are diagrams for explaining a state of the array of the semiconductor devices 901 and 902 arranged on the surfaces of the card substrate 903. As illustrated, on the surfaces of the case substrate 903 (hereinafter, the surface of a −Y side of the card substrate 903 is referred to as a first surface, and the surface of a +Y side thereof is referred to as a second surface), the four semiconductor devices 901 and 902 are arranged along the upward long side of the card substrate 903. As illustrated in the drawing, the semiconductor devices 901 and 902 are provided in a manner that the upper-stage semiconductor devices are arranged in the alternate state along the long side, and in a manner that the lower-stage semiconductor devices are arranged in the alternate state along the long side.

The semiconductor devices 901 and 902 are arranged in a manner that the semiconductor devices 901 and 902 do not exist in positions of one surface of the card substrate 903 opposed to the positions of the semiconductor devices 901 and 902 provided on the other surface of the card substrate 903. Particularly, as illustrated in FIG. 10A and FIG. 10B, on the first and second surfaces of the card substrate 903, the arrangement orders that the upper-stage semiconductor devices or the lower-stage semiconductor devices are arranged along the long side are made the other way round, between the first and second surfaces of the card substrate 903. On the first surface, the arrangement order is “the upper-stage semiconductor device-the lower-stage semiconductor device-the upper-stage semiconductor device-the lower-stage semiconductor device”, along the direction from −X to +X. On the second surface, the arrangement order is “the upper-stage semiconductor device-the lower-stage semiconductor device-the upper-stage semiconductor device-the lower-stage semiconductor device”, along the direction from +X to −X. In this manner, the semiconductor devices 901 and 902 do not exist in the positions of the second surface corresponding to the positions of the semiconductor devices 901 and 902 on the first surface (i.e. the positions just at the back side thereof). As a result, in a state where the card substrates 903 are attached with the main substrate 905, the upper-stage semiconductor devices are arranged in the alternate state, and the lower-stage semiconductor devices are arranged also in the alternate state, also along the Y-axis direction.

Accordingly, among the entire semiconductor devices 901 and 902 implemented on the plurality of card substrates 903, a high difference (a level difference) is always made between the upper surfaces (planes of incidence) of the semiconductor devices 901 and 902 adjacent into the X-axis direction and Y-axis direction. Thus, the semiconductor radiation detector 900 of this embodiment exercises excellent processability or excellent maintainability (operability, such as removing/inserting of the card substrate 903). In addition, there is very little probability that the adjacent semiconductor devices 901 and 902 are in contact with each other, in the same substrate 903 or between the adjacent card substrates 903.

Like the face-on type semiconductor radiation detector 100 of the First Embodiment, in the edge-on type semiconductor radiation detector 900 of this embodiment, the corner parts of the upper-stage semiconductor devices or the lower-stage semiconductor devices may possibly be in contact with each other. This can be solved by cutting off the corner parts of the semiconductor devices 901 and 902, like the case of the First Embodiment.

Like the face-on type semiconductor radiation detector 100 of the First Embodiment, the edge-on type semiconductor radiation detector 900 of the Second Embodiment is usually used in a state where the collimator (a parallel multihole collimator) is arranged upward the semiconductor devices 901 and 902. Like the case of the First Embodiment, some cases may be assumed. In one case, the radial rays get through between the adjacent respective devices. In another case, the radial rays may enter a pixel different from an original target pixel. These cases can be solved by the same method as that of the First Embodiment. Specifically, to overcome the former case, the peripheries of the upper surfaces (planes of incidence) of the lower-stage semiconductor devices are simply expanded to overlap the peripheries of the upper surfaces (planes of incidence) of the upper-stage semiconductor devices. To overcome the latter case, the collimator is configured in a mariner that emission parts of radial rays in holes are adjacent to pixels corresponding to the holes. For example, the lower ends of the collimator (a parallel multihole collimator) are extended up adjacent to the lower-stage semiconductor devices.

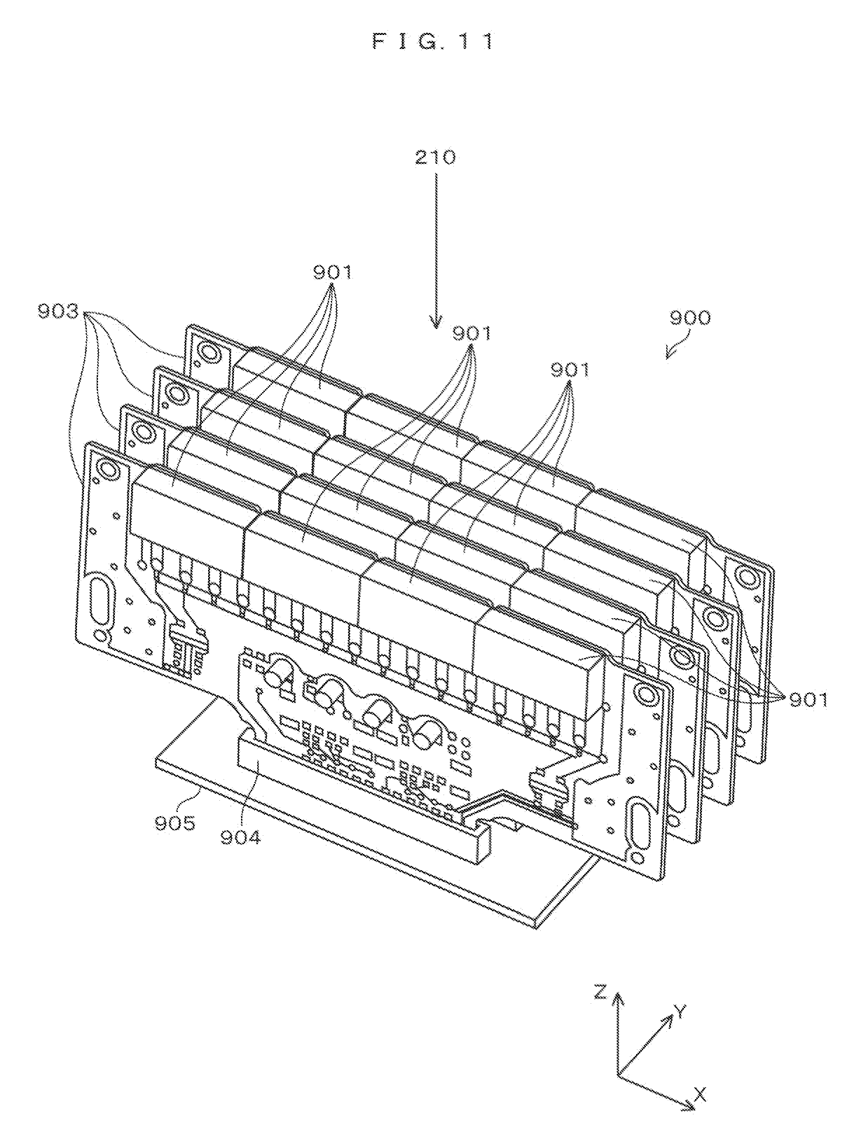

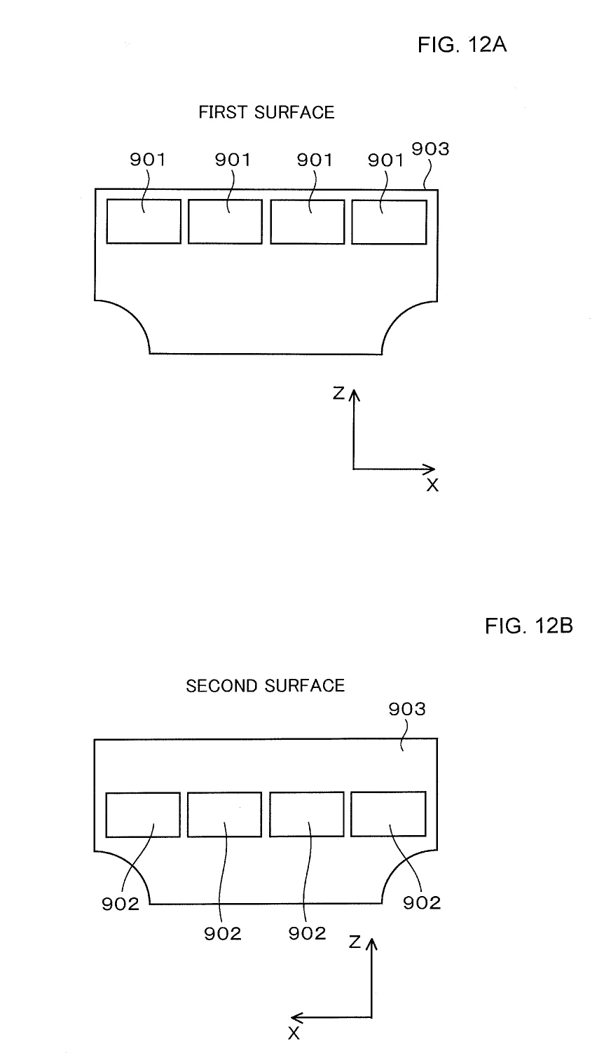

Other than those illustrated in FIG. 9, FIG. 10A, and FIG. 10B, the array forms of the semiconductor devices 901 and 902 provided on the surfaces of the card substrates 903 may possibly be those of FIG. 11, FIG. 12A, and FIG. 12B, for example. In this example, the semiconductor devices 901 and 902 are arranged in a manner that heights in the normal direction of the planes of incidence of the semiconductor devices 901 and 902 are equally given in the first and second surfaces of the card substrate 903. Specifically, as illustrated in FIG. 12A, the four upper-stage semiconductor devices are provided on the first surface of the card substrate 903 along the long side of the card substrate 903. As illustrated in FIG. 12B, the four lower-stage semiconductor devices are provided on the second surface of the card substrate 903 along the long side of the card substrate 903. In this case, in the first surface or the second surface, the upper surfaces of the adjacent semiconductor devices (the upper-stage semiconductor devices or the lower-stage semiconductor devices) have the same height (one plane). However, the upper-stage semiconductor devices or the lower-stage semiconductor devices alternately appear between the upper-stage semiconductor devices of the first surface and the lower-stage semiconductor devices of the second surface, that is, in the Y-axis direction. Thus, as compared with the case where the upper surfaces have the same height between the adjacent semiconductor devices 901 and 902, the semiconductor radiation detector 900 has excellent processability or excellent maintainability (operability, such as removing/inserting of the card substrate 903). In addition, there will be very little probability that the adjacent semiconductor devices 901 and 902 are in contact with each other between the adjacent card substrates 903.

Accordingly, the descriptions have been made to the case where the four card substrates 903 are provided, and the number of semiconductor devices 901 and 902 to be attached to one card substrate 903 is eight. However, the number of card substrates 903 and the number of semiconductor devices 901 and 902 to be attached to one card substrate 903 are not limited to the above.

Accordingly, the embodiments have been described. However, the present invention is not limited to the above-described embodiments, and various modifications are included. For example, the above-described embodiments have specifically been described for easy explanation of the present invention, and are not necessarily limited to those including the above-described constituent elements. Apart of the configuration of one embodiment may be replaced with that of another embodiment, or the configuration of one embodiment may be added to the configuration of another embodiment. A part of the configuration of each embodiment may be added to, deleted from, or replaced with another embodiment.

For example, the descriptions have been made to the case where the radial rays include gamma rays, by way of example. However, the above configuration may be applied widely to cases of any radial rays (alpha rays, beta rays, or X-rays) other than the gamma rays.

What is claimed is:

1. A radiation detector comprising:
a plurality of radiation detecting devices which have planes of incidence where incoming radial rays enter, and the radiation detecting devices being arranged in a manner that the planes of incidence are arranged side by side substantially without any space therebetween when viewed from a direction along which the radial rays come, and
wherein heights in a normal direction of the respective planes of incidence of the radiation detecting devices differ from heights in a normal direction of planes of incidence of respective adjacent other radiation detecting devices.

2. The radiation detector according to claim 1,
wherein the radiation detecting devices have a substantially flat rectangular parallelepiped form,
the plane of incidence is one of surfaces of each of the radiation detecting devices,
the plurality of radiation detectors are arranged in a manner that the respective planes of incidence are arranged side by side substantially without any space therebetween in a direction of two sides of the planes of incidence, and
the radiation detecting devices are arranged in a manner that the heights in the normal direction of the respective planes of incidence differ from heights in a normal direction of the planes of incidence of adjacent other radiation detecting devices along a direction of two sides of the respective planes of incidence.

3. The radiation detector according to claim 1, wherein at least a part of peripheries of the planes of incidence of the radiation detecting devices with the planes of incidence having a low height in the normal direction is configured to overlap peripheries of the planes of incidence of the radiation detecting devices with the planes of incidence having a high height in the normal direction and adjacent to the radiation detecting devices with the low height, when the planes of incidence of the radiation detecting devices are viewed from a normal direction along which the radial rays come.

4. The radiation detector according to claim 1,
wherein the planes of incidence of the radiation detecting devices are parted to a plurality of pixels,
there is included a parallel multihole collimator which restricts a direction of radial rays entering the respective pixels, and
the collimator is configured in a manner that emission parts of the radial rays in holes of the parallel multihole collimator are adjacent to the pixels corresponding to the holes.

5. The radiation detector according to claim 1, wherein a part of peripheries of the planes of incidence of the radiation detecting devices is cut off to an extent to prevent contact of the planes of incidence of the adjacent radiation detecting devices whose planes of incidence have an equal height in a normal direction.

6. The radiation detector according to claim 1,
wherein the radiation detecting devices are semiconductor devices having a substantially flat rectangular parallelepiped form,
the plane of incidence is one of surfaces of each of the radiation detecting devices, and
the radiation detecting device includes a circuit which causes a voltage gradient along a normal direction of the plane of incidence.

7. The radiation detector according to claim 6, wherein at least a part of wirings included in the circuit is formed to get through a space between the radiation detecting devices which are arranged adjacently.

8. The radiation detector according to claim 1,
wherein the radiation detecting devices are semiconductor devices having a substantially flat rectangular parallelepiped form,
the plane of incidence is one of surfaces of each of the radiation detecting devices, and
the radiation detecting device includes a circuit which causes a voltage gradient along a direction of 90 degree against the normal direction of the plane of incidence.

9. The radiation detector according to claim 8, comprising:
a first substrate; and
a plurality of second substrates, and
wherein the second substrates have surfaces parallel to each other, and are arranged to stand vertically on a surface of the first substrate, and
the radiation detecting devices are provided on at least one surface of each of the second substrates.

10. The radiation detector according to claim 9,
wherein on each surface of the second substrates, the radiation detecting devices are arranged on the surfaces in a manner that heights in a normal direction of the planes of incidence of the radiation detectors differ from heights in a normal direction of the planes of incidence of respective adjacent other radiation detectors, and
the radiation detecting devices are arranged in a manner that heights in a normal direction of the planes of incidence of the radiation detectors are different also between surfaces of the second substrates.

11. The radiation detector according to claim 9,
wherein on each surface of the second substrates, the radiation detecting devices are arranged on the surfaces in a manner that the heights in the normal direction of the planes of incidence of the radiation detectors are same as the heights in the normal direction of the planes of incidence of the respective adjacent other radiation detectors, and
the radiation detecting devices are arranged in a manner that the heights in the normal direction of the planes of incidence of the radiation detectors are different between surfaces of the second substrates.
